(19) United States
(12) Patent Application Publication
(10) Pub. No.: US 2025/0313055 A1
(43) Pub. Date: Oct. 9, 2025

(54) VALVE-CONTROLLED FLUID CIRCUITS FOR REBOUND DAMPING ADJUSTMENT

(71) Applicant: Fox Factory, Inc., Duluth, GA (US)

(72) Inventor: Andrew Laird, Seattle, WA (US)

(73) Assignee: Fox Factory, Inc., Duluth, GA (US)

(21) Appl. No.: 18/927,803

(22) Filed: Oct. 25, 2024

Related U.S. Application Data
(60) Provisional application No. 63/547,091, filed on Nov. 2, 2023.

(51) Int. Cl. B60G 17/052; F16F 9/02; F16F 9/44

(52) U.S. Cl. CPC B60G 17/0523; F16F 9/44; F16F 9/0281

(57) ABSTRACT

A dual function fluid adjuster assembly. The dual function fluid adjuster assembly has a first adjuster assembly for adjusting a first rebound fluid circuit and a second adjuster assembly for adjusting a second rebound fluid circuit. At least a portion of the first adjuster assembly is at least partially housed within a shaft assembly, and at least a portion of the second adjuster assembly is at least partially housed within the shaft assembly.

### CROSS-REFERENCE TO RELATED APPLICATIONS (PROVISIONAL)

This application claims priority to and benefit of co-pending U.S. Provisional Patent Application No. 63/547,091 filed on Nov. 2, 2023, entitled “VALVE-CONTROLLED FLUID CIRCUITS REBOUND DAMPING ADJUSTMENT VIA SHAFT MOUNTED ADJUSTER MECHANISM” and assigned to the assignee of the present application, the disclosure of which is hereby incorporated by reference in its entirety.

### FIELD OF THE INVENTION

Embodiments of the invention generally relate to methods and apparatus useful for a shock assembly.

### BACKGROUND OF THE INVENTION

Shock assemblies (e.g., dampers, shock absorbers, etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. However, depending upon the terrain being traversed, it can be valuable to be able to modify one or more rebound characteristics of the shock assembly for personal comfort, vehicle performance, and the like, on the fly.

### BRIEF DESCRIPTION OF THE DRAWINGS

FIG. 1A is a perspective view of a shock assembly having a plurality of valve-controlled fluid circuits for rebound damping adjustment, in accordance with one embodiment.

FIG. 1B is a side section view of the shock assembly of FIG. 1A, in accordance with one embodiment.

FIG. 2A is a side view of a shaft assembly with a plurality of valve-controlled fluid circuits, in accordance with one embodiment.

FIG. 2B is a side view of the shaft assembly with a plurality of valve-controlled fluid circuits of FIG. 2A without the eyelet shown, in accordance with one embodiment.

FIG. 2C is a side section view of the shaft assembly without the eyelet shown with a plurality of valve-controlled fluid circuits of FIG. 2A, in accordance with one embodiment.

FIG. 3A is a top perspective view of the shaft piston end portion of the shaft assembly, in accordance with one embodiment.

FIG. 3B is a side section view of the shaft piston end portion of the shaft assembly, in accordance with one embodiment.

FIG. 4A is a perspective view of the eyelet end portion of the shaft assembly without the eyelet shown having an interactive portion of the plurality of valve-controlled fluid circuits, in accordance with one embodiment.

FIG. 4B is a side section view of the eyelet end portion of the shaft assembly without the eyelet shown, in accordance with one embodiment.

FIG. 4C is a perspective section view of the eyelet end portion of the shaft assembly without the eyelet shown, in accordance with one embodiment.

FIG. 5A is a front section view of the user interactive portion of the user adjustable rebound circuit for adjusting the first valve-controlled fluid circuit, in accordance with one embodiment.

FIG. 5B is a front section view of the user interactive portion of the user adjustable rebound circuit for adjusting the second valve-controlled fluid circuit, in accordance with one embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

In general, a suspension system for a vehicle provides a motion modifiable connection between a portion of the vehicle that is in contact with a surface (e.g., an unsprung portion) and some or all of the rest of the vehicle that is not in contact with the surface (e.g., a suspended portion). For example, the unsprung portion of the vehicle that is in contact with the surface can include one or more wheel(s), skis, tracks, hulls, etc., while some or all of the rest of the vehicle that is not in contact with the surface include suspended portions such as a frame, a seat, handlebars, engines, cranks, etc.

In its basic form, the suspension is used to increase ride comfort, performance, endurance, component longevity and the like. In general, the force of jarring events, rattles, vibrations, jostles, and the like which are encountered by the portion of the vehicle that is in contact with the surface are reduced or even removed as it transitions through the suspension before reaching suspended portions of the vehicle to include components such as seats, steering wheels/handlebars, pedals/foot pegs, fasteners, drive trains, engines, and the like.

The suspension system will include one or numerous components which are used to couple the unsprung portion of the vehicle (e.g., wheels, skids, wings, etc.) with the suspended portion of the vehicle (e.g., seat, cockpit, passenger area, cargo area, etc.). Often, the suspension system will include one or more shock assemblies which are used to reduce feedback from the unsprung portion of the vehicle before that feedback is transferred to the suspended portion of the vehicle, as the vehicle traverses an environment. However, the language used by those of ordinary skill in the art to identify a shock assembly used by the suspension system can differ while referring to the same (or similar) types of components. For example, some of those of ordinary skill in the art will refer to the shock assembly as a shock absorber, while others of ordinary skill in the art will refer to the shock assembly as a damper (or damper assembly).

As used herein, the terms “down”, “up”, “downward”, “upward”, “lower”, “upper”, and other directional references are relative and are used for reference and identification purposes.

In the following discussion, the term “active”, as used when referring to a valve or shock assembly component, means adjustable, manipulatable, etc., during typical operation of the valve. For example, an active valve can have its operation changed to thereby alter a corresponding shock assembly characteristic damping from a “soft” setting to a “firm” setting (or a stiffness setting somewhere therebetween) by, for example, adjusting a switch in a passenger compartment of a vehicle. Additionally, it will be understood that in some embodiments, an active valve may also be configured to automatically adjust its operation, and corresponding shock assembly damping characteristics, based upon, for example, operational information pertaining to the vehicle and/or the suspension with which the valve is used.

Similarly, it will be understood that in some embodiments, an active valve may be configured to automatically adjust its operation, and corresponding shock assembly damping characteristics, based upon received user input settings (e.g., a user-selected “comfort” setting, a user-selected “sport” setting, and the like). In many instances, an “active” valve is adjusted or manipulated electronically (e.g., using a powered solenoid, or the like) to alter the operation or characteristics of a valve and/or other component. As a result, in the field of suspension components and valves, the terms “active”, “electronic”, “electronically controlled”, and the like, are often used interchangeably.

In the following discussion, the term “manual” as used when referring to a valve or shock assembly component means manually adjustable, physically manipulatable, etc., without requiring disassembly of the valve, damping component, or shock assembly which includes the valve or damping component. In some instances, the manual adjustment or physical manipulation of the valve, damping component, or shock assembly which includes the valve or damping component, occurs when the valve is in use. For example, a manual valve may be adjusted to change its operation to alter a corresponding shock assembly damping characteristic from a “soft” setting to a “firm” setting (or a stiffness setting somewhere therebetween) by, for example, manually rotating a knob, pushing or pulling a lever, physically manipulating an air pressure control feature, manually operating a cable assembly, physically engaging a hydraulic unit, and the like. For purposes of the present discussion, such instances of manual adjustment/physical manipulation of the valve or component can occur before, during, and/or after “typical operation of the vehicle”.

It should further be understood that a vehicle suspension may also be referred to using one or more of the terms “passive”, “active”, “semi-active” or “adaptive”. As is typically used in the suspension art, the term “active suspension” refers to a vehicle suspension which controls the vertical movement of the wheels relative to vehicle. Moreover, “active suspensions” are conventionally defined as either a “pure active suspension” or a “semi-active suspension” (a “semi-active suspension” is also sometimes referred to as an “adaptive suspension”). In a conventional “pure active suspension”, a motive source such as, for example, an actuator, is used to move (e.g. raise or lower) a wheel with respect to the vehicle. In a “semi-active suspension”, no motive force/actuator is employed to adjust move (e.g. raise or lower) a wheel with respect to the vehicle.

Rather, in a “semi-active suspension”, the characteristics of the suspension (e.g. the firmness of the suspension) are altered during typical use to accommodate conditions of the terrain and/or the vehicle. Additionally, the term “passive suspension”, refers to a vehicle suspension in which the characteristics of the suspension are not changeable during typical use, and no motive force/actuator is employed to adjust move (e.g. raise or lower) a wheel with respect to the vehicle. As such, it will be understood that an “active valve”, as defined above, is well suited for use in a “pure active suspension” or a “semi-active suspension”.

Embodiments provided herein disclose a new and novel first and second fluid rebound circuits that allow a user to adjust the rebound damping characteristics of a shock assembly without rebuilding an internal valving mechanism. In one embodiment, at least some portion of the first adjuster assembly is partially housed (e.g., disposed) within a portion of a shaft assembly. In one embodiment, at least some portion of the second adjuster assembly is partially housed within a portion of the shaft assembly. In one embodiment, at least some portion of the first adjuster assembly is partially housed within a portion of a shaft assembly and at least some portion of the second adjuster assembly is partially housed within a portion of the shaft assembly. Embodiments of the present invention having at least some portion of the first adjuster assembly partially housed within a portion of the shaft assembly and/or at least some portion of the second adjuster assembly partially housed within a portion of the shaft assembly are well suited to use with a more standard shaft-displacement monotube shock. In the present discussion, the shaft assembly comprises, for example, a main shaft, a shaft end mounting feature (such as, but not limited to, a shaft end eyelet, a strut mounting feature, a trunnion structure, or the like), and a main piston assembly. One embodiment also integrates a variable spring rate mechanism for damping adjustment in conjunction with the first and second fluid rebound circuits removing the need for an adjustable preload mechanism, thereby providing further refinement capabilities or shaping of the rebound damping curve.

In some embodiments, the first fluid circuit is a fluid circuit referred to, in the suspension art, as a high-speed circuit. Additionally, in some embodiments, the second fluid circuit is a fluid circuit referred to, in the suspension art, as a low-speed circuit. Further, in embodiments of the present invention, the first fluid circuit, the first fluid circuit valve and adjuster, the second fluid circuit, and the second fluid circuit valve and adjuster are used to adjust fluid flow during a rebound event of a suspension. Additionally, in embodiments of the present invention, the first fluid circuit, the first fluid circuit valve and adjuster, the second fluid circuit, and the second fluid circuit valve and adjuster are used to adjust fluid flow during a compression event of a suspension. Additionally, in embodiments of the present invention, the first fluid circuit, the first fluid circuit valve and adjuster, the second fluid circuit, and the second fluid circuit valve and adjuster are used to adjust fluid flow during both a rebound event of a suspension and a compression event of a suspension.

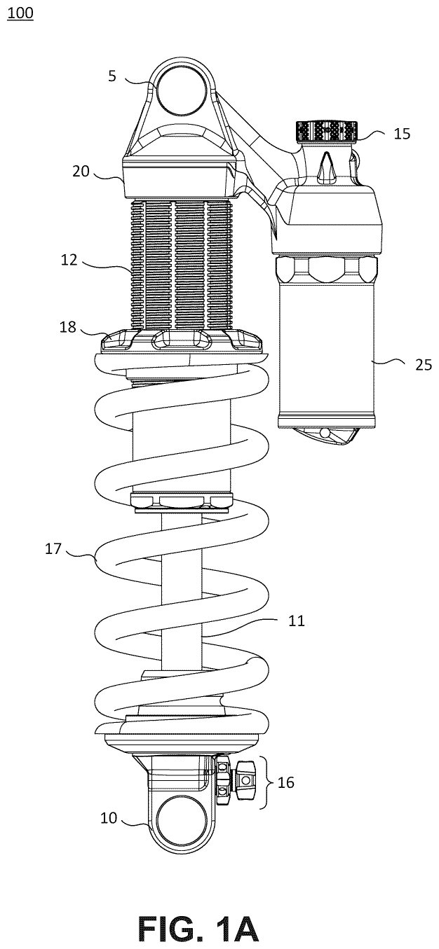

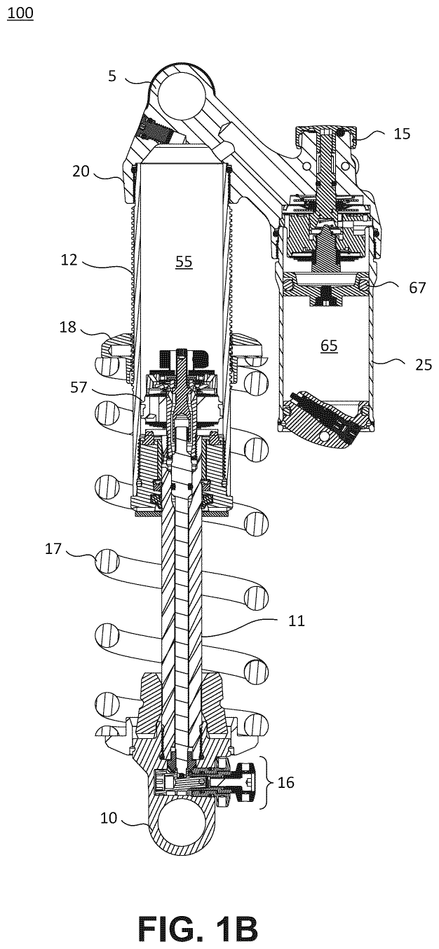

Referring now to FIG. 1A, a perspective view of a shock assembly 100 having a plurality of valve-controlled fluid circuits for rebound damping adjustment is shown in accordance with an embodiment. In one embodiment, shock assembly 100 is a monotube shock assembly. In one embodiment, shock assembly 100 is a monotube coil-over shock assembly, such as, for example, a FOX 2.0 Zero QS3-R shock assembly.

Although in one embodiment the shock assembly 100 is a monotube coil-over style shock assembly, in another embodiment, the shock assembly 100 is a FLOAT X2 air shock assembly. In general, an air shock assembly is a high-performance shock assembly that uses air as springs, instead of heavy steel coil springs or expensive titanium coil springs. In another embodiment, the shock assembly 100 may be another type of shock assembly such as, but not limited to, a stand-alone fluid damper assembly, a coil sprung adjustable shock assembly, an air sprung fluid damper assembly, a twin-tube shock assembly, or the like.

Shock assembly 100 includes one or more coil-over springs 17, a spring preload adjuster 18, a body 12, a body cap 20, and a fluid reservoir 25. In one embodiment, the fluid reservoir is located within body 12. In one embodiment, fluid reservoir 25 is a remote fluid reservoir. A configuration of an external and/or side fluid reservoir 25, including a floating piston, is described in U.S. Pat. No. 7,374,028 the content of which is incorporated by reference herein, in its entirety.

Shock assembly 100 includes attachment features such as, in one embodiment, body cap eyelet 5 and shaft-end eyelet 10. In one embodiment, body cap eyelet 5 is used as a chassis mounting point while the shaft-end eyelet 10 is frame mounted to allow shock assembly 100 to be coupled between the unsprung portion of the suspension (e.g., the components of the suspension affected by, or in contact with, the terrain) and the sprung portion. In one embodiment, if the shock assembly 100 is installed in an inverted configuration, body cap eyelet 5 would be the frame mount and shaft-end eyelet 10 would be the chassis mount.

Shock assembly 100 includes a user interactive portion 16 of a rebound circuit. In one embodiment, user interactive portion 16 provides a manual adjustment capability to one or more rebound damping characteristics of the shock assembly 100. Additional detail of the shaft assembly rebound circuit including the user interactive portion 16 is discussed in further detail herein including the discussion of the shaft assembly 200. In one embodiment, one or more components of the rebound circuit are electronically actuated. E.g., a signal is received by an actuator which modifies a damping characteristic.

In one embodiment, shock assembly 100 optionally includes a user adjustment assembly 15 portion of a compression circuit. In one embodiment, user adjustment assembly 15 provides a manual adjustment capability to one or more compression damping characteristics of the shock assembly 100. In one embodiment, one or more components of the compression circuit are electronically actuated. In one embodiment, there is no user adjustment assembly 15 coupled with the shock assembly 100 and any adjustments to the compression circuit are electronically actuated.

For additional detail and description of a shock assembly, see, as an example, U.S. Pat. No. 10,576,803 the content of which is incorporated by reference herein, in its entirety. For additional detail and description of position-sensitive shock absorber/damper, see, as an example, U.S. Pat. No. 6,296,092 the content of which is incorporated by reference herein, in its entirety. For additional detail and description of adjustable compression and/or rebound damping, preload, crossover, bottom-out, and the like for a shock absorber/damper, see, as an example, U.S. Pat. No. 10,036,443 the content of which is incorporated by reference herein, in its entirety.

Although components of FIG. 1A, are shown in given locations in accordance with one embodiment, in other embodiments, one, some, or all of the components shown in FIG. 1A could be inverted, located in other locations, one or more components could be separated into two or more pieces and dispersed, two or more components could be integrated into a single piece, etc. The use of the locations of the components as shown in FIG. 1A is indicative of one embodiment, which is provided for purposes of clarity.

With reference now to FIG. 1B, a cross-section view of shock assembly 100 of FIG. 1A is shown in accordance with an embodiment. For purpose of clarity, in the discussion of FIG. 1B, all of the components described in FIG. 1A are incorporated by reference in their entirety.

In one embodiment, body 12 includes a fluid filled chamber 55 therein and shaft 11 has a piston 57 coupled therewith. In one embodiment, the piston 57 is coupled to a partially threaded, end portion of the shaft 11, and fixedly connected thereto by virtue of a nut or bolt or other fastening mechanism threadedly secured on the end portion to secure the piston 57 with the shaft 11.

In one embodiment, the fluid volume within chamber 55 is bifurcated by the piston 57 into two variable volumes: a compression volume and a rebound volume. For example, in one embodiment, piston 57 includes about the outer circumference thereof a plurality of ring shaped lip or other types of seals, to enable sealing of the piston 57 against the inner surface of the body 12 and thus across the piston 57 between the compression volume and the rebound volume.

Piston 57 is configured to enable flow therethrough based upon the pressure difference between the compression volume and the rebound volume portions of chamber 55. This is enabled, in one embodiment, by the use of “shims” (sometimes referred to as a piston shim(s)) on either side of the piston 57, which are configured to selectively overlay one or more piston 57 openings extending through the piston 57 to selectively open fluid communication between the compression volume and the rebound volume portions of chamber 55, respectively. The stiffness of the shims, and the number and configurations of the shims, determines the differential pressure at which the shim will bend away from the piston 57 openings and thus allow fluid flow from a higher pressure volume to a lower pressure volume directly there through. Additionally, although the term “shims” is used herein for clarity and brevity, it should be noted that the present invention is well suited to use with, and, in fact, some embodiments of the present invention utilize, a single shim.

In one embodiment, the fluid reservoir 25 has a reservoir chamber 65 that is divided by an internal floating piston (IFP) 67. In one embodiment, one side of the IFP 67 divided reservoir chamber 65 is filled with a pressurized gas (e.g., nitrogen, or the like) and the other side of reservoir chamber 65 is fluidly coupled with chamber 55 of body 12 via one or more fluid flow paths. In general, the IFP 67 keeps the pressurized gas from mixing with the working fluid. Various embodiments utilize other mechanisms to provide a force to the IFP. Such mechanisms include, but are not limited, a spring. Other embodiments will use a bladder assembly in lieu of an IFP.

In general operation, the piston 57 disposed on the shaft 11 moves within the damper housing (or body 12) in response to forces imposed on the body 12 and the shaft 11. The movement of piston 57 is dampened by the presence of the fluid in the chamber 55. In order for the piston 57 to move within chamber 55, fluid on one side of the piston 57 (e.g., on the compression side) must be able to move to another location (such as the rebound side) and vice-versa. In one embodiment, the fluid can move to the different side by passing through the one or more valved openings in the piston 57. In a bypass configuration, the fluid can move to the different side using one or more valved openings in a bypass assembly, valved openings to an optional secondary reservoir fluidly connected to chamber 55, and the like.

During a compression stroke, the available fluid volume within chamber 55 is reduced by the incursion of the shaft 11. This reduction in volume results in an amount of shaft displaced fluid. E.g., fluid that can no longer fit within the reduced fluid volume availability of chamber 55. During the rebound stroke, the available fluid volume within chamber 55 is increased by the withdrawal of a portion of the shaft 11 and as such, the shaft displaced fluid will need to be reintroduced into chamber 55. As such, during a compression stroke the shaft displaced fluid in chamber 55 is able to move to the reservoir 25 through valved openings fluidly connecting reservoir 25 with chamber 55.

Thus, in one embodiment, the rate of fluid flow between the fluid volumes on either side of the piston 57, and between the fluid volumes in chamber 55 and reservoir 25, is used to modify, adjust, or otherwise tune the dampening effect of the shock assembly 100.

In general, shock assembly 100 is used in applications such as, but not limited to an exoskeleton, a seat frame, a prosthetic, an orthotic, a suspended floor, and the like. Further, the present shock assembly with the first fluid circuit and the second fluid circuit is incorporated into vehicles such as, but not limited to a road bike, a mountain bike, a gravel bike, an electric bike (e-bike), a hybrid bike, a scooter, a motorcycle, an ATV, a personal water craft (PWC), an aircraft, a single wheeled vehicle, a four-wheeled vehicle, a multi-wheeled vehicle, a snow mobile, a UTV such as a side-by-side, and the like. Examples of different shock assemblies and utilizations are disclosed in U.S. Pat. Nos. 6,296,092; 7,374,028; 9,033,122; 9,120,362; 9,239,090; 9,353,818; 9,623,716; 10,036,443; 10,427,742; 10,576,803 and 11,091,215 the contents of which are incorporated by reference herein, in their entirety.

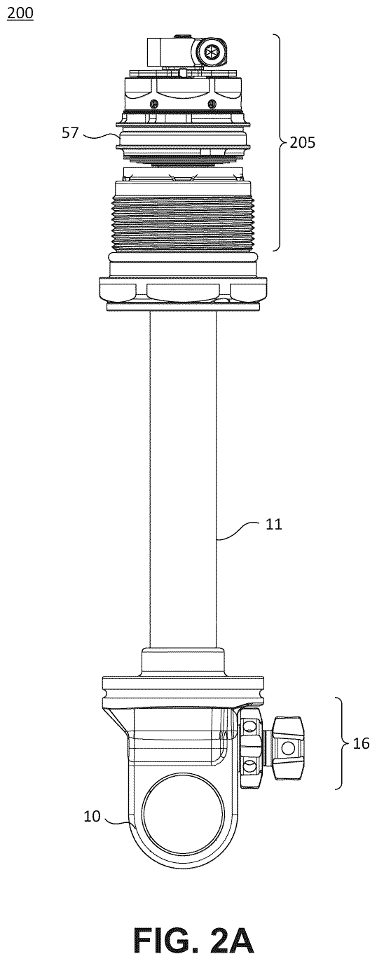

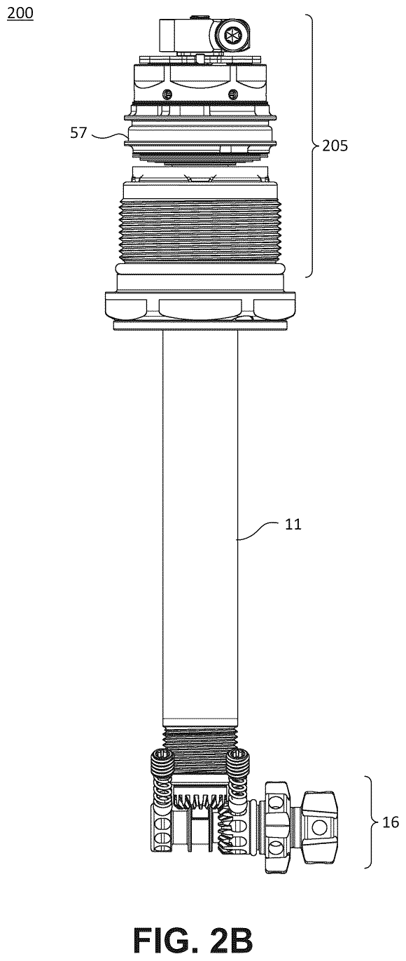

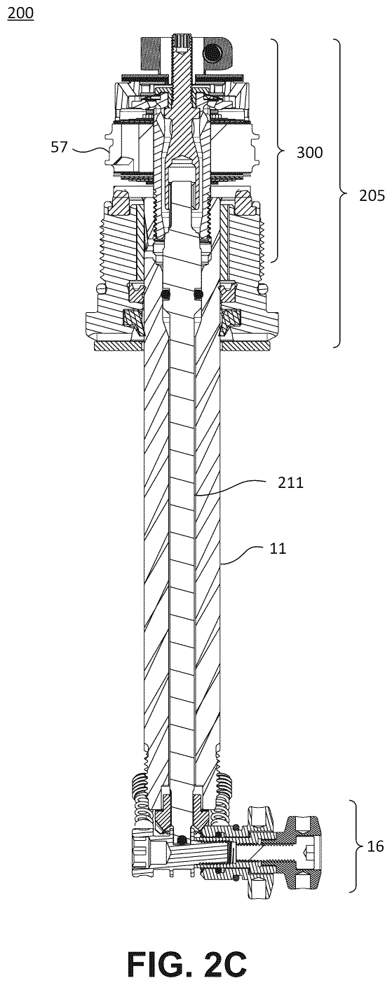

With reference now to FIG. 2A, a side view of a shaft assembly 200 with a plurality of valve-controlled fluid circuits is shown in accordance with one embodiment. FIG. 2B is a side view of the shaft assembly 200 with a plurality of valve-controlled fluid circuits without the shaft-end eyelet 10 to better illustrate the user interactive portion 16 of the plurality of valve-controlled fluid circuits, in accordance with one embodiment.

As will be described in more detail herein, shaft assembly 200 includes shaft piston end portion 205 of the shaft assembly 200, the shaft 11, and the shaft-end eyelet 10 components of the shaft assembly 200.

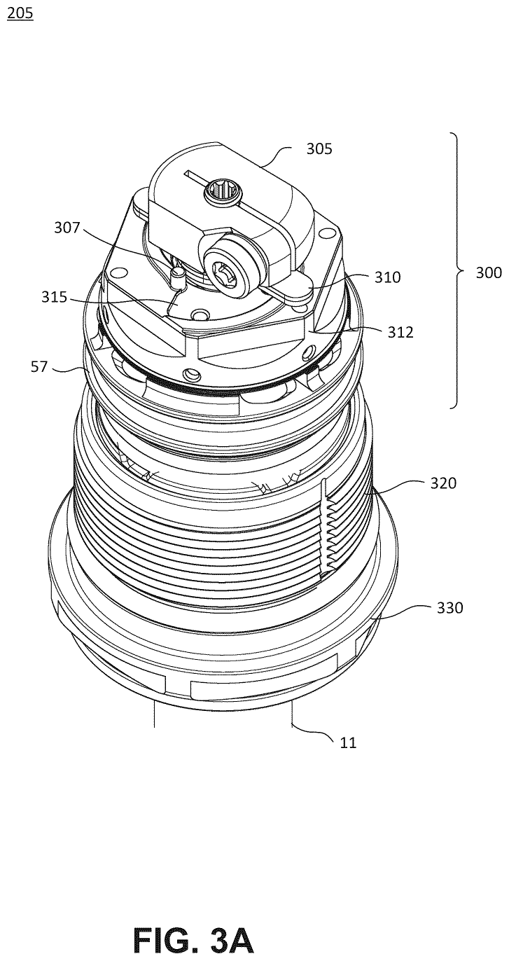

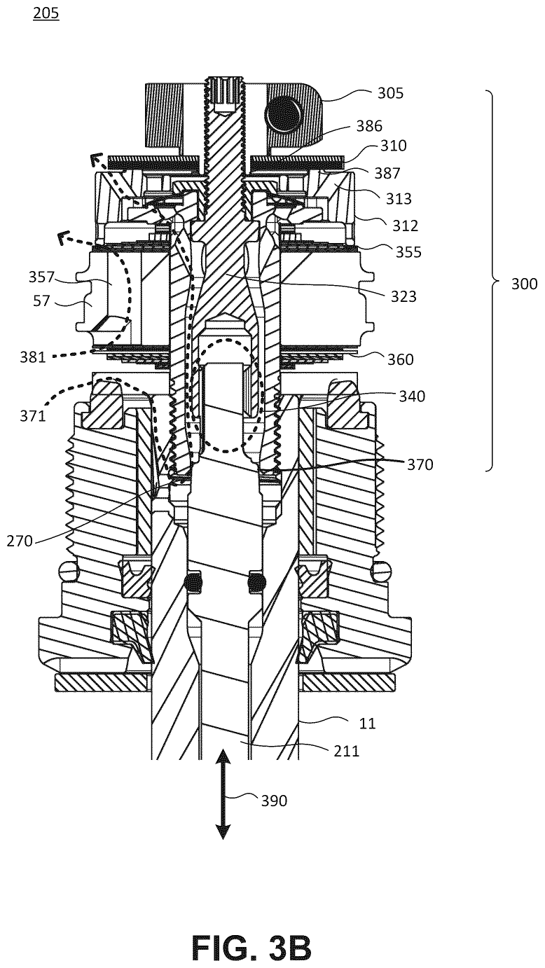

The shaft piston end portion 205 includes a variable valve control (VVC) assembly 300 having a plurality of valve-controlled fluid circuits shown and described in further detail with respect to FIGS. 3A and 3B.

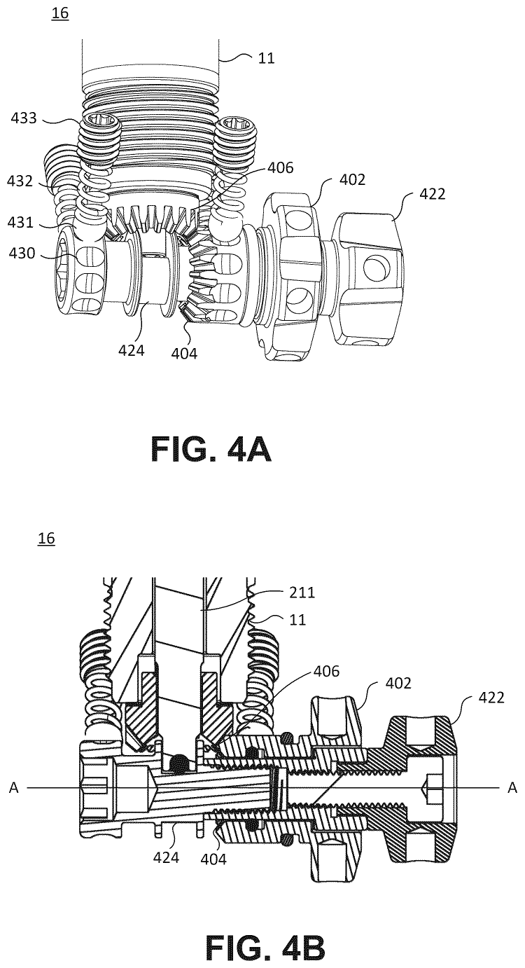

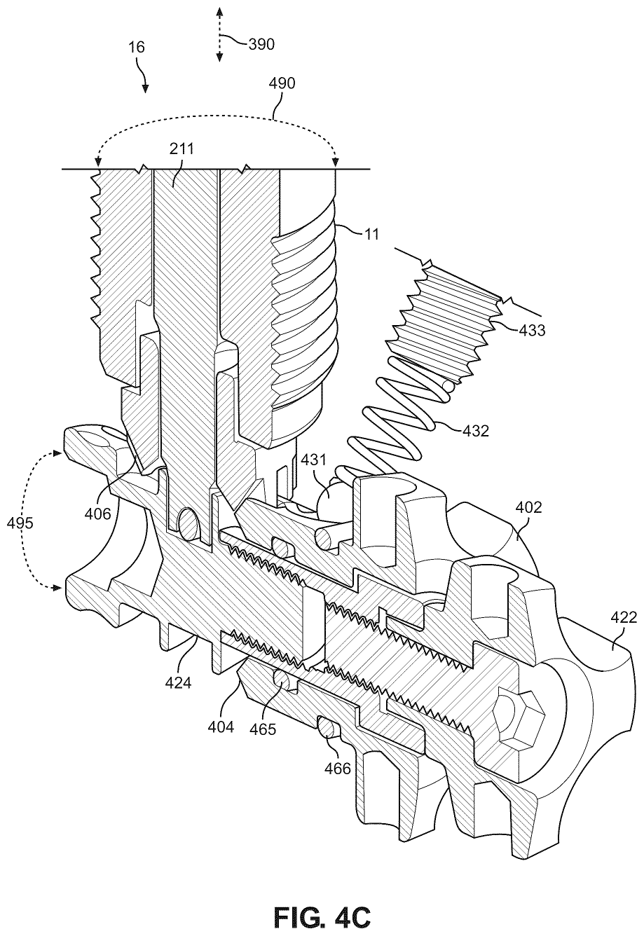

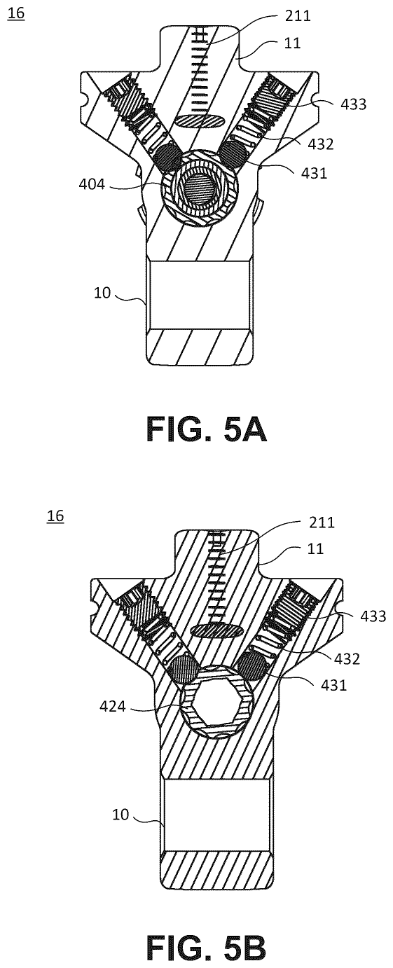

The shaft-end eyelet 10 of the shaft assembly 200 includes a user interactive portion 16 for receiving the adjustments that are translated to one or more of the plurality of valve-controlled fluid circuits in shaft piston end portion 205, shown and described in further detail with respect to FIGS. 4A-4C and 5A-5B.

Although components of FIGS. 2A and 2B, are shown in given locations in accordance with one embodiment, in other embodiments, one, some, or all of the components shown in FIGS. 2A and 2B could be inverted, located in other locations, one or more components could be separated into two or more pieces and dispersed, two or more components could be integrated into a single piece, etc. The use of the locations of the components as shown in FIGS. 2A and 2B are indicative of one embodiment, which is provided for purposes of clarity.

FIG. 2C is a side section view of the shaft assembly 200 with a plurality of valve-controlled fluid circuits in accordance with one embodiment. For purpose of clarity, in the discussion of FIG. 2C, all of the components described in FIGS. 2A and 2B are incorporated by reference in their entirety.

In FIG. 2C, the translation features of the shaft 11 are shown and described. In one embodiment, shaft 11 is hollow and an adjuster rod 211 is located therein. For purposes of the present discussion, both rotational and axial movement may be described as translation. In one embodiment, adjuster rod 211 is translatable rotationally and/or axially with respect to shaft 11. As discussed in more detail herein, the adjuster rod 211 is used to transmit one or more inputs from the user interactive portion 16 to the one or more of the plurality of valve-controlled fluid circuits in shaft piston end portion 205.

In one embodiment, instead of a single adjuster rod 211 within shaft 11, at least two nested adjuster rods are located within shaft 11. For purposes of the present discussion, the phrase “an adjuster rod assembly” may be used. An adjuster rod assembly, as used herein, refers to one or more adjuster rod(s) which transmits one or more inputs from a user interactive portion to one or more of a plurality of valve-controlled fluid circuits. In one embodiment, wherein the adjuster rod assembly contains a single adjuster rod, the single adjuster rod will move axially (e.g., within shaft 11, in one embodiment) based upon a first input from the user interactive portion, and the same single adjuster rod will move rotationally (e.g., within shaft 11, in one embodiment) based upon a second input from the user interactive portion. In one embodiment, wherein the adjuster rod assembly contains two adjuster rods, the interior most nested adjuster rod will move axially within shaft 11 and the outer nested rod will move rotationally within shaft 11. In one embodiment, the interior most nested adjuster rod will move rotationally within shaft 11 and the outer nested rod will move axially within shaft 11. For the present discussion, nested is intended to refer to having one element (e.g., a first adjuster rod) concentrically disposed with respect to another element (e.g., a second adjuster rod).

In one embodiment, an adjuster rod assembly, having adjuster rod 211, includes an internal fluid passage to provide a fluid pathway through the shaft such as disclosed and described in U.S. patent application Ser. No. 18/382,324, the content of which is incorporated by reference in its entirety.

Referring now to FIG. 3A, a top perspective view of the shaft piston end portion 205 of the shaft assembly 200 is shown in accordance with one embodiment. In one embodiment, shaft piston end portion 205 includes VVC assembly 300, piston 57, bearing assembly 320, and bearing cap 330.

In one embodiment, VVC assembly 300 includes a clamp nut 305, VVC shims 310 (such as leaf springs, springs, or the like), VVC plate 312. In one embodiment, plate 312 has a spiral portion 315 top surface used in conjunction with a hard stop 307 to limit a rotation thereof. Additionally, although the term “VVC shims 310” is used herein for clarity and brevity, it should be noted that the present invention is well suited to use with, and, in fact, some embodiments of the present invention utilize, a single VVC shim.

FIG. 3B is a side section view of the shaft piston end portion 205 of the shaft assembly 200 in accordance with one embodiment. For purpose of clarity, in the discussion of FIG. 3B, all of the components described in FIG. 3A are incorporated by reference in their entirety.

In one embodiment, piston 57 is shown with rebound shim stack 355 and compression shim stack 360 at either side thereof used as control valving for the fluid pathway(s) or port(s) 357 traversing axially through piston 57 (e.g., along the same general direction as directional arrows 390).

In one embodiment, piston 57 is attached to the shaft 11 via a threaded portion and has a hollow interior within which adjuster rod 211 is located.

### Second Fluid Rebound Circuit 371

In one embodiment, the hollow interior provides a portion of the flow path for the second fluid rebound circuit 371 (or low speed rebound circuit). Thus, in one embodiment, the second fluid rebound circuit 371 is a fluid pathway from the rebound side of chamber 55, into the interior of shaft 11, through the piston 57, through port(s) 313 of VVC plate 312, and out into the compression side of chamber 55.

In one embodiment, an adjuster rod assembly, having adjuster rod 211 includes a tapered portion (e.g., taper 270) that interacts with the attachment features of piston 57, e.g., bolt(s) used to attach piston 57 to shaft 11, to form an adjustable orifice 370 along the flow path of the second fluid rebound circuit 371. In one embodiment, adjuster rod 211 includes a tapered portion (e.g., taper 270) that interacts with a feature of shaft 11, to form an adjustable orifice 370 along the flow path of the second fluid rebound circuit 371. As such, the fluid flow through fluid rebound circuit 371 is metered by adjusting the size of the orifice 370. In one embodiment, the size of the orifice 370 is adjusted by moving the adjuster rod 211 axially (as shown by directional arrow 390) within shaft 11. For example, as adjuster rod 211 is moved upward (e.g., toward piston 57) the taper 270 widens to fill the gap and close orifice 370. In contrast, when adjuster rod 211 is moved downward (e.g., away from piston 57), the taper 270 narrows and the gap of orifice 370 opens. Therefore, in one embodiment, by controlling the axial position of adjuster rod 211, the flow rate of the second fluid rebound circuit 371 is controlled.

In one embodiment, instead of a taper 270 and axial movement of adjuster rod 211 affecting the size of orifice 370, the size of orifice 370 is adjusted by the rotation of adjuster rod 211. For example, a rotational component (such as a threaded nut or the like) that closes off orifice 370 as it is turned by the adjuster rod 211. In another embodiment, a radially varying groove or machined profile opens or closes orifice 370 as the adjuster rod 211 is turned.

Thus, adjusting the second fluid rebound circuit 371 will adjust the rebound damping characteristics. In one embodiment, it will adjust the lower speed rebound characteristics such as speeds less than twenty to thirty inches per second.

### First Fluid Rebound Circuit 381

First fluid rebound circuit 381 is a fluid pathway from the rebound side of chamber 55, through port(s) 357 of piston 57, past the deflected rebound shim stack 355, and out into the compression side of chamber 55.

In one embodiment, VVC assembly 300 forms a portion of the adjustable first fluid rebound circuit 381 (or high speed rebound circuit). In one embodiment, VVC assembly 300 includes the clamp nut 305, VVC shims 310, VVC plate 312, and VVC shaft 323 coupled with an adjuster rod assembly which includes adjuster rod 211.

In one embodiment, the clamp nut 305 is threadedly coupled with VVC shaft 323. In another embodiment, the clamp nut 305 is fixedly coupled with VVC shaft 323 via another method such as being pressed, formed from a single piece, or the like.

In one embodiment, VVC shaft 323 is coupled with an adjuster rod assembly, which includes adjuster rod 211, via a slideable interface 340 such that a rotation of adjuster rod 211 will rotate the VVC shaft 323 while axial movement of the adjuster rod 211 will not translate into axial movement of the VVC shaft 323. In one embodiment slidable interface 340 is a splined interface. In one embodiment, slideable interface 340 is a geometric shaped interface (e.g., triangular, square, rectangle, etc.). In another embodiment, VVC shaft 323 is coupled with adjuster rod 211 via another rotational coupling system that provides axial movement freedom between the VVC shaft 323 and the adjuster rod 211.

In one embodiment, movement of the adjuster rod assembly (e.g., via movement of externally adjustable feature 402 and/or via movement of externally adjustable feature 422), which includes adjuster rod 211, will cause rotation of VVC shaft 323, clamp nut 305 and VVC shims 310, while VVC plate 312 does not rotate. In another embodiment, movement of the adjuster rod assembly (e.g., via movement of externally adjustable feature 402 and/or via movement of externally adjustable feature 422), which includes adjuster rod 211, will cause rotation of VVC shaft 323 and VVC plate 312, while VVC shims 310 do not rotate. Thus, in various embodiments of the present invention, movement of the adjuster rod assembly (e.g., via movement of externally adjustable feature 402 and/or via movement of externally adjustable feature 422), will cause rotational movement of VVC plate 312 and VVC shims 310 with respect to each other. As is described below, in various embodiments, rotational movement of VVC plate 312 and VVC shims 310 with respect to each other varies the effective stiffness of VVC shims 310.

Referring now to FIGS. 3A and 3B, in one embodiment, the rotation of clamp nut 305 in a first direction will increase the torque applied by clamp nut 305 onto the VVC shims 310. In contrast, the rotation of clamp nut 305 in a second direction (opposite the first direction) will decrease the torque applied by clamp nut 305 onto the VVC shims 310.

In general, VVC shims 310 rest on spiral portion 315 of VVC plate 312. In one embodiment, spiral portion 315 provides a radially varying surface that changes the effective stiffness of the shims 310 as the VVC shaft 323 and clamp nut 305 are rotated. In one embodiment, the spiral portion radially varies from an innermost location, e.g., a pivot point 386 to an outermost location, e.g., seat 387 along the path of rotation. In one embodiment, the maximum rotation of the VVC shaft 323 and clamp nut 305 in a given direction is controlled by at least one hard stop 307.

In another embodiment, instead of the VVC shims 310 rotating with the rotation of VVC shaft 323 and clamp nut 305, while having the spiral portion 315 of VVC plate 312 remaining stationary, the spiral portion 315 and/or VVC plate 312 will rotate with the rotation of VVC shaft 323, while the VVC shims 310 will remain stationary. In other words, the outer diameter (OD) to inner diameter (ID) pressure points (of spiral portion 315 for example) applied to the VVC shims 310 utilize two components that move relative to one another to provide the adjustability.

In general, changing the location of the pressure point being applied to the VVC shim 310 will increase or decrease the effective stiffness force required for VVC plate 312 to move in the axial direction (as indicated by arrow 390). In other words, when the pressure is applied to the VVC shim 310 at the outermost seat 387 location, VVC shim 310 will be in its most easily flexed position providing the least amount of force against an upward axial movement of VVC plate 312. In contrast, when the pressure is applied to the VVC shim 310 at pivot point 386, VVC shim will be in its firmest setting providing the greatest force against an upward axial movement of VVC plate 312. Additionally, although the term “VVC shim 310” is used herein for clarity and brevity, it should be noted that the present invention is well suited to use with, and, in fact, some embodiments of the present invention utilize, a plurality of VVC shims.

As VVC plate 312 is located against the rebound shim stack 355, any change in the force (or pressure) required to move VVC plate 312 upward axially will result in a related change to the blowoff or cracking pressure required to open rebound shim stack 355.

In operation, the first fluid rebound circuit 381 allows fluid to flow from the rebound side, through port(s) 357 of piston 57, deflecting the rebound shim stack 355, and into the compression side of chamber 55.

Thus, adjusting the first fluid rebound circuit 381 will adjust the rebound damping characteristics. In one embodiment, it will adjust higher speed rebound characteristics such as, for example, speeds greater than twenty to thirty inches per second.

In another embodiment, a spring is used, and a translation of an adjuster rod assembly, which includes adjuster rod 211, adds or removes preload to the spring which acts against the VVC shim 310, VVC plate 312, and/or rebound shim stack 355.

In one embodiment, instead of (or in addition to) the use of the spiral motion of the VVC plate 312 causing a change in the cracking pressure of VVC shim 310, the rotation of adjuster rod 211 will change the cracking pressure of VVC shim 310 and/or the pressure imparted on rebound shim stack 355 by the VVC plate 312. For example, in one embodiment, a spring is used, where a rotation of adjuster rod 211 adds or removes preload to the spring which acts against the VVC shim 310, VVC plate 312, and/or rebound shim stack 355.

With reference now to FIG. 4A, a perspective view of the eyelet end portion of the shaft assembly 200 having a user interactive portion 16 of the plurality of valve-controlled fluid circuits is shown in accordance with one embodiment.

In one embodiment, the user interactive portion 16 includes a first adjuster assembly for the first fluid rebound circuit 381 and a second adjuster assembly for the second fluid rebound circuit 371.

In one embodiment, first adjuster assembly for the first fluid rebound circuit 381 includes an externally adjustable feature 402 which is rotationally coupled with a transmission component (such as, for example, but not limited to, a gear 404 and associated adjuster rod gear 406) which is then coupled to adjuster rod 211. In another embodiment, first adjuster assembly for the first fluid rebound circuit 381 includes an externally adjustable feature 402 which is rotationally coupled with a transmission component (such as, for example but not limited to, a gear 404 and associated adjuster rod gear 406), and at least one apparatus for providing position control and/or feedback. As will be described in detail below, in one embodiment, externally adjustable feature 402 is used modify the flow rate of fluid through the first fluid rebound circuit 381. For the present discussion, the transmission component includes one or more features, elements, or parts which transmit movement of externally adjustable feature 402 to adjuster rod 211. In various embodiments of the present invention, the first adjuster assembly will include a greater number of elements or features than are recited in the present description of embodiments. Also, in various embodiments of the present invention, the first adjuster assembly will include a lesser number of elements or features than are recited in the present description of embodiments. Moreover, in various embodiments of the present invention, the first adjuster assembly will include different elements or features than those recited in the present description of embodiments. That is, embodiments of the first adjuster assembly are well suited to having different elements or features and/or to having different combinations of elements or features to provide fluid control for the first fluid rebound circuit 381.

In one embodiment, second adjuster assembly for the second fluid rebound circuit 371 includes an externally adjustable feature 422 which is rotationally coupled with a transmission component (such as, for example, but not limited to, a radially varying component (such as a cam 424)) which is then coupled to adjuster rod 211. In another embodiment, second adjuster assembly for the second fluid rebound circuit 371 includes externally adjustable feature 422 and at least one apparatus for providing position control and/or feedback. As will be described in detail below, in one embodiment, externally adjustable feature 422 is used modify the flow rate of fluid through the second fluid rebound circuit 371. Moreover, for the present discussion, the transmission component includes one or more features, elements, or parts which transmit movement of externally adjustable feature 422 to adjuster rod 211. In various embodiments of the present invention, the second adjuster assembly will include a greater number of elements or features than are recited in the present description of embodiments. Also, in various embodiments of the present invention, the second adjuster assembly will include a lesser number of elements or features than are recited in the present description of embodiments. Moreover, in various embodiments of the present invention, the second adjuster assembly will include different elements or features than those recited in the present description of embodiments. That is, embodiments of the second adjuster assembly are well suited to having different elements or features and/or to having different combinations of elements or features to provide fluid control for the second fluid rebound circuit 371.

In one embodiment, externally adjustable feature 402 (and similarly externally adjustable feature 422) is a knob. In another embodiment, manually accessible external adjustable feature 402 (and similarly externally adjustable feature 422) is a button, lever, tooled adjuster (e.g., hex, wrench, screwdriver, or the like), switch, electronic display, in-vehicle infotainment (IVI) system, computing device, or the like which can be manually manipulated by a user to change one or a plurality of damping characteristics of shock assembly 100. In one embodiment, the manual adjustment capability is located with shaft-end eyelet 10. In one embodiment, the adjustment capability is located remote from shaft-end eyelet 10 such as a lever on a handlebar, frame, cockpit, etc. In one embodiment, the remote adjustment capability is coupled with shock assembly 100 via a physical connection (e.g., cable, hydraulic, wired, etc.). In one embodiment, the remote adjustment capability is wirelessly coupled with shock assembly 100. Various embodiments may also utilize other user interfaces to control the adjustments of the first fluid circuit and/or second fluid circuit.

In one embodiment, the at least one apparatus for providing position control and/or feedback includes one or more detent(s) 430 formed in a portion of cam 424, gear 404, externally adjustable feature 422 and/or externally adjustable feature 402 and/or externally adjustable feature 422. A set screw 433, spring 432, and ball 431 are used to fit with detent(s) 430 and provide an amount of resistance. The resistance can be adjusted to ensure that the externally adjustable feature(s) do not move without an input. The resistance is also adjustable to provide user personalized levels of input force required to modify the position of the externally adjustable feature(s). In one embodiment, the detent(s) 430 provide a desired movement for each adjustment to the position of the externally adjustable feature(s) and as such, a similarly established amount of adjustment to the second fluid rebound circuit 371 and first fluid rebound circuit 381. In one embodiment, a different type of position control and/or feedback apparatus is used.

FIG. 4B is a side section view of the eyelet end portion of the shaft assembly 200 including the user interactive portion 16 in accordance with one embodiment. FIG. 4C is a perspective section view of the eyelet end portion of the shaft assembly 200 including the user interactive portion 16, in accordance with one embodiment. For purpose of clarity, in the discussion of FIGS. 4B and 4C, all of the components described in FIG. 4A are incorporated by reference in their entirety.

With reference now to FIGS. 4A-4C, in one embodiment, cam 424 has a radially varying diameter. In another embodiment, cam 424 has another type of geometric shape with varying radial distances about an axis thereof. An adjuster rod assembly, including adjuster rod 211, sits against the outer diameter of cam 424 and will move up or down (as shown by directional arrow 390 of FIG. 4C) with the changing radius of cam 424. In one embodiment, the fluid pressure in chamber 55 provides a downward force on adjuster rod 211 causing adjuster rod 211 to remain in contact with cam 424. In another embodiment, a spring provides a downward force on adjuster rod 211 causing adjuster rod 211 to remain in contact with cam 424.

To modify the second fluid rebound circuit 371 the externally adjustable feature 422 is adjusted. As externally adjustable feature 422 is adjusted, cam 424 will rotate (as shown by rotational indicator 495 of FIG. 4C) about longitudinal axis A-A (of FIG. 4B). As cam 424 is rotated, the radius of the material about the outer diameter of cam 424 will also vary. Adjuster rod 211 sits against the outer diameter of cam 424 and will move up or down (as shown by directional arrow 390 of FIG. 4C) with the changing radius of cam 424. As discussed herein, the up and down movement of adjuster rod 211 will open, close, and/or change the size of the opening of orifice 370 (of FIG. 3B). This will modify the flow rate of fluid through the second fluid rebound circuit 371 to change a damping characteristic of shock assembly 100.

In one embodiment, instead of a cam 424, a conical needle is used as the radially varying component. As the externally adjustable feature 422 is adjusted, the conical needle will move in or out to adjust the radial portion of the conical needle in contact with adjuster rod 211 causing adjuster rod 211 to move in direction (as shown by arrow 390) and open, close, and/or change the size of the opening of orifice 370 (of FIG. 3B).

In one embodiment, gear 404 is rotationally coupled with the externally adjustable feature 402 and meshed with the associated adjuster rod gear 406. In one embodiment, adjuster rod gear 406 is coupled with adjuster rod 211 via a slideable interface (similar to slideable interface 340 of FIG. 3B) such that a rotation of adjuster rod gear 406 will rotate the adjuster rod 211 while axial movement of the adjuster rod 211 will not disconnect the adjuster rod gear 406 from its mesh with gear 404. In one embodiment, the slidable interface is a splined interface. In one embodiment, the slideable interface is a geometric shaped interface (e.g., triangular, square, rectangle, etc.). In another embodiment, adjuster rod gear 406 is coupled with adjuster rod 211 via another rotational coupling system that provides axial movement freedom between the adjuster rod gear 406 and the adjuster rod 211.

When gear 404 is rotated (as shown by rotational indicator 495 of FIG. 4C) about longitudinal axis A-A (of FIG. 4B) the rotation is translated into an axial rotation (as shown by rotational indicator direction 490 of FIG. 4C) of adjuster rod gear 406 which rotates adjuster rod 211. In one embodiment, a bottom portion of shaft 11 is used to maintain the position of adjuster rod gear 406 within the shaft-end eyelet 10 and mesh with gear 404.

To modify the first fluid rebound circuit 381, the externally adjustable feature 402 is adjusted. As externally adjustable feature 402 is adjusted, gear 404 will rotate. As gear 404 rotates, the adjuster rod gear 406 will rotate and transmit the rotary movement into the axial rotation of adjuster rod 211. As discussed herein, the rotational movement of adjuster rod 211 will increase or decrease the cracking pressure of VVC shim 310 (of FIG. 3B) and thus the cracking pressure of rebound shim stack 355. This change in rebound shim stack 355 cracking pressure will modify a damping characteristic of shock assembly 100. Additionally, although the term “VVC shim 310” is used herein for clarity and brevity, it should be noted that the present invention is well suited to use with, and, in fact, some embodiments of the present invention utilize, a plurality of VVC shims.

In one embodiment, instead of a gear arrangement (such as, for example, gear(s), work gear(s), beveled gear(s) or a combination thereof) or the like, the transmission component includes a direct sliding spine arrangement. As the externally adjustable feature 402 is adjusted, the sliding spline will move along axis A-A causing the adjuster rod 211 to rotate axially in direction 490 and increase or decrease the cracking pressure of VVC shim (or shims) 310 (of FIG. 3B) and thus the cracking pressure of rebound shim stack 355. As stated above, various embodiments may also utilize other user interfaces to control the adjustments of the first fluid circuit and/or second fluid circuit.

With reference now to FIG. 4C, in one embodiment seal 465 is used between the externally adjustable feature 402 and externally adjustable feature 422 to provide an offset such that movement of externally adjustable feature 402 or externally adjustable feature 422 will not be transferred into the other. Seal 466 is used between the externally adjustable feature 402 and the body of shaft-end eyelet 10 to provide space such that movement of externally adjustable feature 402 will not bind with respect to the body of shaft-end eyelet 10. In one embodiment, one or both of seal 465 and seal 466 also maintain sufficient space such that the force pushing down on adjuster rod 211 will not act to skew cam 424, externally adjustable feature 402, and/or externally adjustable feature 422.

In one embodiment, externally adjustable feature 402, and/or externally adjustable feature 422 will have visual and/or tactile differences to provide user recognition of the two different adjuster assemblies (i.e., the first adjuster assembly and the second adjuster assembly).

For example, in one embodiment, externally adjustable feature 402, and/or externally adjustable feature 422 will include numbers, arrows, and/or other identifying features that will allow a user to visually identify one or more predefined settings, directions to turn the knob for different performance aspects, and the like.

In one embodiment, externally adjustable feature 402 and/or externally adjustable feature 422 will have different tactile feel, shape, spacing, resistance, or the like to provide user recognition without requiring the user to look at the externally adjustable feature 402, and/or externally adjustable feature 422 while making a desired adjustment to the appropriate circuit. In one embodiment one or more of externally adjustable feature 402 and externally adjustable feature 422 are readily removable by a user to remove or install spring 17 or other elements.

Referring now to FIG. 5A, a front section view of the user interactive portion 16 of the user adjustable rebound circuit for adjusting the first valve-controlled fluid rebound circuit 381 is shown in accordance with one embodiment.

In one embodiment, the arrangement of the user interactive portion 16 for adjusting the first valve-controlled fluid rebound circuit 381 is shown in a configuration to fit within the body of shaft-end eyelet 10. In one embodiment, the components include the bevel gear 404 and the set screws 433, springs 432, balls 431. In one embodiment, using a “v” type configuration and orientation allows most of the components of the user interactive portion 16 to fit within the footprint of shaft-end eyelet 10 and in so doing, will provide a configuration that will fit in many and/or all existing applications without requiring redesign of the shock assembly or mounting location/fit.

In one embodiment, the arrangement of the user interactive portion 16 for adjusting the first valve-controlled fluid rebound circuit 381 is provided in a different configuration within the body of shaft-end eyelet 10, such as inline, or the like. In one embodiment, the arrangement of the user interactive portion 16 for adjusting the first valve-controlled fluid rebound circuit 381 is made in a configuration to fit within a different style of the body of shaft-end eyelet 10, to only fit partially within the body of shaft-end eyelet 10, to expand outside the footprint of the shaft-end eyelet 10, or the like.

FIG. 5B is a front section view of the user interactive portion 16 of the user adjustable rebound circuit for adjusting the second valve-controlled fluid rebound circuit 371, in accordance with one embodiment.

In one embodiment, the arrangement of the user interactive portion 16 for adjusting the second valve-controlled fluid rebound circuit 371 is shown in a configuration to fit within the body of shaft-end eyelet 10. In one embodiment, the components include the cam 424 and the set screws 433, springs 432, balls 431. In one embodiment, using a “v” type configuration and orientation allows most of the components of the user interactive portion 16 to fit within the footprint of shaft-end eyelet 10 and in so doing, will provide a configuration that will fit in many and/or all existing applications without requiring redesign of the shock assembly or mounting location/fit.

In one embodiment, the arrangement of the user interactive portion 16 for adjusting the second valve-controlled fluid rebound circuit 371 is provided in a different configuration within the body of shaft-end eyelet 10, such as inline, or the like. In one embodiment, the arrangement of the user interactive portion 16 for adjusting the first valve-controlled fluid rebound circuit 381 is made in a configuration to fit within a different style of the body of shaft-end eyelet 10, to only fit partially within the body of shaft-end eyelet 10, to expand outside the footprint of the shaft-end eyelet 10, or the like.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A dual function fluid adjuster assembly comprising:
a first adjuster assembly for adjusting a first rebound fluid circuit; and
a second adjuster assembly for adjusting a second rebound fluid circuit, wherein said first adjuster assembly and said second adjuster assembly form said dual function fluid adjuster assembly, wherein at least a portion of said first adjuster assembly is at least partially disposed within a shaft assembly, and wherein at least a portion of said second adjuster assembly is at least partially disposed within said shaft assembly.

2. The dual function fluid adjuster assembly of claim 1, wherein an externally adjustable feature of said first adjuster assembly and an externally adjustable feature of said second adjuster assembly are independently adjustable such that movement of one of said externally adjustable feature of said first adjuster assembly or said externally adjustable feature of said second adjuster assembly can be made without causing movement of the other of said externally adjustable feature of said first adjuster assembly or said externally adjustable feature of said second adjuster assembly.

3. The dual function fluid adjuster assembly of claim 1, wherein said at least a portion of said first adjuster assembly is at least partially disposed within a first portion of said shaft assembly and wherein said at least a portion of said second adjuster assembly is at least partially disposed within a second portion of said shaft assembly.

4. The dual function fluid adjuster assembly of claim 3, wherein said first portion of said shaft assembly and said second portion of said shaft assembly are a same portion of said shaft assembly.

5. The dual function fluid adjuster assembly of claim 1, further comprising:
a transmission component; and
an adjuster rod assembly at least partially disposed within at least a portion of said shaft assembly, said adjuster rod assembly coupled with said transmission component such that movement of an externally adjustable feature of said first adjuster assembly will cause a rotational movement of said adjuster rod assembly.

6. The dual function fluid adjuster assembly of claim 5, wherein said transmission component is selected from the group consisting of: a gear, a work gear, a beveled gear or a combination thereof.

7. The dual function fluid adjuster assembly of claim 5, wherein said transmission component is a sliding spline.

8. The dual function fluid adjuster assembly of claim 1, further comprising:
a radially varying component; and
an adjuster rod assembly at least partially disposed within at least a portion of said shaft assembly, said adjuster rod assembly coupled with said radially varying component such that movement of an externally adjustable feature of said second adjuster assembly will cause an axial movement of said adjuster rod assembly within said shaft assembly.

9. The dual function fluid adjuster assembly of claim 8, wherein said radially varying component is a cam.

10. The dual function fluid adjuster assembly of claim 8, wherein said radially varying component is a taper and screw.

11. The dual function fluid adjuster assembly of claim 5, further comprising:
a piston having at least one fluid path therethrough;
at least one piston shim coupled with said piston and at least partially covering said at least one fluid path;
a variable valve control (VVC) shaft coupled with said adjuster rod assembly;
at least one VVC shim; and
a VVC plate coupled with said VVC shaft, wherein rotational movement of said VVC plate with respect to said at least one VVC shim varies an effective stiffness of said at least one VVC shim.

12. A dual function fluid adjuster assembly for a monotube shock, said dual function fluid adjuster assembly comprising:
a first adjuster assembly for adjusting a first rebound fluid circuit of said monotube shock; and
a second adjuster assembly for adjusting a second rebound fluid circuit of said monotube shock, wherein said first adjuster assembly and said second adjuster assembly form said dual function fluid adjuster assembly, wherein said first adjuster assembly and said second adjuster assembly are configured for use in said monotube shock.

13. A dual function fluid adjuster assembly comprising:
an externally adjustable feature of a first adjuster assembly, said first adjuster assembly for adjusting a first fluid circuit;
an externally adjustable feature of a second adjuster assembly, said second adjuster assembly for adjusting a second fluid circuit, wherein said externally adjustable feature of said first adjuster assembly and said externally adjustable feature of said second adjuster assembly are nested; and
an adjuster rod assembly coupled with said externally adjustable feature of said first adjuster assembly, said adjuster rod assembly coupled with said externally adjustable feature of said second adjuster assembly, said adjuster rod assembly configured to move axially to control one of said first fluid circuit or said second fluid circuit, and said adjuster rod assembly configured to move rotationally to control the other of said first fluid circuit or said second fluid circuit.

14. The dual function fluid adjuster assembly of claim 13, wherein said adjuster rod assembly includes a single adjuster rod.

15. The dual function fluid adjuster assembly of claim 13, wherein said adjuster rod assembly includes a plurality of adjuster rods.

16. A dual function fluid adjuster assembly comprising:
a first adjuster assembly for adjusting a first rebound fluid circuit;
a second adjuster assembly for adjusting a second rebound fluid circuit, wherein said first adjuster assembly and said second adjuster assembly form said dual function fluid adjuster assembly; and
an adjuster rod assembly coupled with said first adjuster assembly and said second adjuster assembly, said adjuster rod assembly configured to move axially to control one of said first rebound fluid circuit or said second rebound fluid circuit, and said adjuster rod assembly configured to move rotationally to control the other of said first rebound fluid circuit or said second rebound fluid circuit.

17. The dual function fluid adjuster assembly of claim 16, wherein said adjuster rod assembly includes a single adjuster rod.

18. The dual function fluid adjuster assembly of claim 16, wherein said adjuster rod assembly includes a plurality of adjuster rods.

19. A suspension comprising:
a first fluid circuit comprising:
an externally adjustable feature of a first adjuster assembly;
a transmission component coupled with said externally adjustable feature of said first adjuster assembly;
an adjuster rod assembly having at least a portion thereof disposed within a shaft assembly, said adjuster rod assembly having at least one adjuster rod coupled with said transmission component;
a variable valve control (VVC) shaft coupled with said adjuster rod assembly;
at least one VVC shim; and
a VVC plate coupled with said VVC shaft wherein rotational movement of said VVC plate with respect to said at least one VVC shim varies an effective stiffness of said at least one VVC shim; and
a second fluid circuit comprising:
an externally adjustable feature of a second adjuster assembly;
a radially varying component coupled with said externally adjustable feature of said second adjuster assembly;
a fluid path having at least a portion thereof disposed within said shaft assembly; and
said adjuster rod assembly coupled with said radially varying component, said adjuster rod assembly having a radially varying portion, said radially varying portion of said adjuster rod assembly passing through said fluid path.

20. The suspension of claim 19, wherein said externally adjustable feature of said first adjuster assembly and said externally adjustable feature of said second adjuster assembly are nested, said externally adjustable feature of said first adjuster assembly and said externally adjustable feature of said second adjuster assembly are independently adjustable such that one of said externally adjustable feature of said first adjuster assembly or said externally adjustable feature of said second adjuster assembly can be adjusted without affecting the other of said externally adjustable feature of said first adjuster assembly or said externally adjustable feature of said second adjuster assembly.

21. The suspension of claim 19, said adjuster rod assembly comprising:
a plurality adjuster rods.

22. The suspension of claim 21, wherein said plurality of adjuster rods are nested with respect to each other.

23. The suspension of claim 19, wherein a movement of one of said externally adjustable feature of said first adjuster assembly or said externally adjustable feature of said second adjuster assembly will cause said rotational movement of said VVC plate with respect to said at least one VVC shim.

24. The suspension of claim 19, wherein an axial movement of said adjuster rod assembly is configured to change a size of an orifice formed between said adjuster rod assembly and a piston retaining component coupled with said shaft assembly such that movement of said adjuster rod assembly is able to affect fluid flow through said fluid path.

25. The suspension of claim 19, wherein said transmission component is selected from the group consisting of: a gear, a work gear, a beveled gear, a sliding spine or a combination thereof.

26. The suspension of claim 19, wherein said radially varying component is selected from the group consisting of: a cam and a taper and screw.
